(19) United States
(12) Patent Application Publication
(10) Pub. No.: US 2010/0074641 A1
(43) Pub. Date: Mar. 25, 2010

(54) IMAGE FORMING APPARATUS AND TRANSFER BIAS COMPENSATION METHOD OF THE SAME

(75) Inventor: Sunao Takenaka, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/550,599

(22) Filed: Aug. 31, 2009

Related U.S. Application Data
(60) Provisional application No. 61/099,725, filed on Sep. 24, 2008.

(51) Int. Cl. G03G 15/16

(52) U.S. Cl. 399/66

(57) ABSTRACT

An electrode pair provided upstream of a transfer section in a conveyance direction nips a recording medium and applies an AC bias. A characteristic detection section detects a characteristic of a recording medium when the AC bias is applied. A control section refers to a corresponding relation of a storage section based on a characteristic value detected by the characteristic detection section, and compensates a transfer bias value applied to the transfer section.

### CROSS-REFERENCE TO RELATED APPLICATION

The present application claims priority under 35 U.S.C. 119 to U.S. Provisional Application Ser. No. 61/099,725, entitled IMAGE FORMING APPARATUS, to Takenaka, filed on Sep. 24, 2008, the entire disclosure of which is incorporated herein by reference.

### TECHNICAL FIELD

The present invention relates to an image forming apparatus and a transfer bias compensation method of the image forming apparatus.

### BACKGROUND

An image forming apparatus includes an image carrier and a transfer device to transfer a toner image to a recording medium. The image carrier is a photoconductive body or an intermediate transfer belt.

The transfer device includes a transfer member such as a transfer roller. The transfer member transfers the toner image formed on the image carrier to the recording medium.

Hitherto, a control method in which the resistance of a transfer member is measured in a state where there is no recording medium, and the measured resistance value is reflected in a bias applied to the transfer member is widely used in an image forming apparatus.

U.S. Pat. No. 5,179,397 (corresponding to JP-A-2-264278) teaches an image forming apparatus with constant voltage and constant current control.

In U.S. Pat. No. 5,179,397, when a recording medium does not exist in a transfer device, a CPU (Central Processing Unit) causes a power source to perform constant current control on a transfer roller. The CPU stores a voltage value V1 generated in the transfer roller.

When a recording medium exists in the transfer device, the CPU causes the power source to perform constant voltage control on the transfer roller.

U.S. Pat. No. 5,179,397 discloses that the CPU controls the power source so that the transfer roller is subjected to constant voltage control with a voltage V2 obtained by multiplying the voltage value V1 by a coefficient R (R>1).

The image forming apparatus disclosed in U.S. Pat. No. 5,179,397 previously estimates the resistance value of the recording medium and compensates the bias based on the estimated value.

JP-A-2008-120514 discloses that when a recording sheet passes through register rollers, resistance values of the register rollers and the recording sheet are detected.

JP-A-2008-40128 discloses an image forming apparatus in which when a sheet is not nipped between a photoconductive drum and a transfer roller, a printer controller applies a test voltage to the transfer roller, and a current detection section acquires a current value when the test voltage is applied.

JP-A-2008-40128 discloses that an offset voltage value is added to a calculated transfer bias voltage only when the current value is within a specified range.

However, in the above related art, when the electric resistance of the recording medium is widely different from the estimated value, the intensity of a transfer electric field becomes insufficient or excessive.

The insufficient or excessive intensity of the transfer electric field causes an insufficient or excessive amount of toner to be transferred. As a result, there arises a problem that an optimum image can not be obtained.

The electric characteristic, such as an electric resistance, of a recording medium is changed according to the change of environment such as humidity or the kind of the recording medium such as a paper type. Thus, in the related art, when the resistance change of the recording medium exceeding an estimation occurs, the value of the transfer bias to be applied to the recording medium can not be changed to a value corresponding to this change.

### SUMMARY

It is an object of the present invention to provide an image forming apparatus in which a transfer bias of an appropriate magnitude is applied according to the change of electric characteristic of a recording medium due to the kind of the recording medium or the change of environment.

In an aspect of the present invention, an image forming apparatus includes an image forming section which has an image carrier and forms a developer image on the image carrier, a transfer section to transfer the developer image on the image carrier to a recording medium, a transfer bias supply section to supply a transfer bias voltage to the transfer section, an electrode pair provided upstream of the transfer section in a conveyance direction of the recording medium and for nipping the recording medium and for applying an AC bias to the recording medium, a characteristic detection section to detect an electric characteristic value of the recording medium when the electrode pair applies the AC bias, a storage section to store a corresponding relation between the detected characteristic value and a transfer bias value, and a control section to refer to the corresponding relation of the storage section based on the characteristic value detected by the characteristic detection section and to compensate the transfer bias value applied to the recording medium.

### DESCRIPTION OF THE DRAWINGS

FIG. 1 is a structural view of a color copier including an image forming apparatus of a first embodiment;

FIG. 2 is an enlarged view of a secondary transfer section;

FIG. 3A is a view showing an example of a secondary bias control system including a power source circuit;

FIG. 3B is a view showing an equivalent circuit of a secondary transfer section;

FIG. 4 is a perspective view of a switch;

FIG. 5A is a view showing an equivalent circuit of a Vpp (peak-to-peak voltage) measurement section;

FIG. 5B is a view showing an example of a voltage detection circuit;

FIG. 5C is a view showing a waveform of a signal inputted to the voltage detection circuit;

FIG. 5D is a view showing a waveform of a signal outputted from the voltage detection circuit;

FIG. 6A is a view showing a mechanism to nip a sheet and a state where the sheet is being nipped;

FIG. 6B is view showing the mechanism to nip a sheet and a state where the sheet is released;

FIG. 7 is a diagram showing humidity characteristics of respective volume resistivities of surface materials of three kinds of polyimide resins;

FIG. 8 is a view showing an example of data stored in a table;

FIG. 9 is a structural view of a monochrome copier including an image forming apparatus of a second embodiment of the invention; and

FIG. 10 is a view showing a main part of a color copier including an image forming apparatus of a modified example of the second embodiment.

### DETAILED DESCRIPTION

Throughout this description, the embodiments and examples shown should be considered as exemplars, rather than limitations on the apparatus and methods of the present invention.

Hereinafter, an image forming apparatus and a transfer bias compensation method of the image forming apparatus will be described in detail with reference to the accompanying drawings. Incidentally, in the respective drawings, the same portion is denoted by the same reference numeral and its duplicative description is omitted.

### First Embodiment

An image forming apparatus of a first embodiment is a tandem color copier capable of performing color printing. The color copier uses four color photoconductive drums to primarily transfer four color toner images to an intermediate transfer body, and secondarily transfers the four color toner images to a sheet.

A transfer bias compensation method of the image forming apparatus of the first embodiment is a method in which a control program installed in the color copier causes a secondary transfer device to compensate a secondary transfer bias.

In the method, before an image is transferred to a sheet, a CPU of the color copier causes a mechanism for measuring an impedance of a sheet to apply an AC (Alternate Current) voltage between the front and back of the sheet.

The CPU compensates a secondary transfer bias value based on the peak-to-peak value of a voltage signal outputted in response to the inputted AC voltage. The CPU sends the compensated secondary transfer bias value to the secondary transfer device.

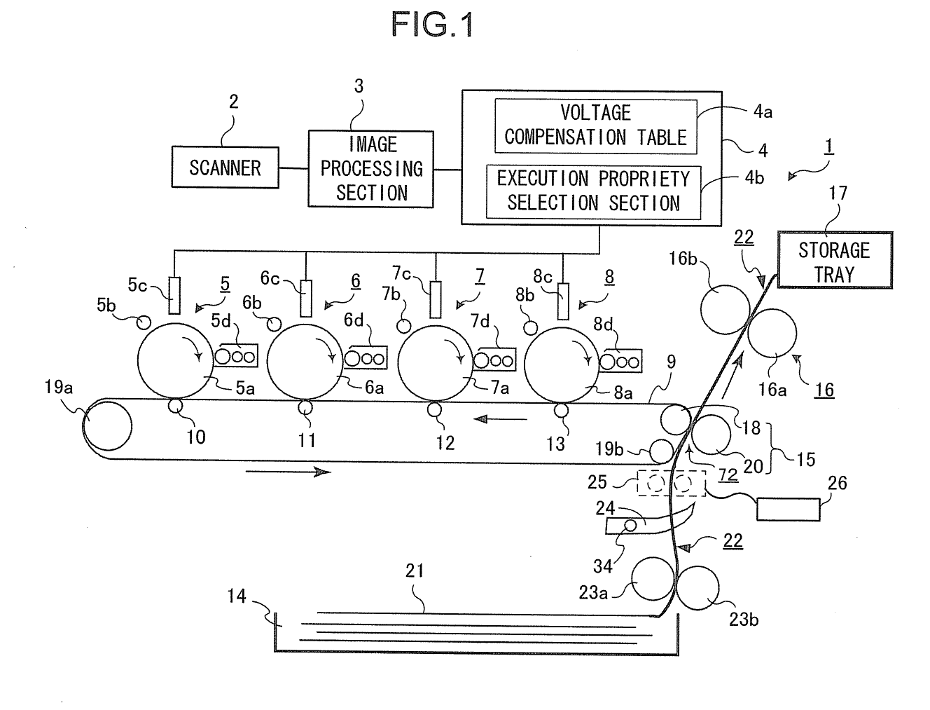

FIG. 1 is a structural view of the color copier including the image forming apparatus of the first embodiment.

The color copier 1 includes a scanner 2, an image processing section 3, a control section 4, image forming sections 5, 6, 7 and 8, an intermediate transfer belt 9, primary transfer rollers 10, 11, 12 and 13, a sheet feed cassette 14, a secondary transfer section 15, a fixing unit 16 and a storage tray 17.

The scanner 2 optically reads an original document, and generates image data of three colors of R, G and B.

The image processing section 3 converts the image data of each color of R, G and B into data of four colors of K, C, M and Y.

The image processing section 3 includes a CPU, a ROM (Read Only Memory), a RAM (Random Access Memory) and an LSI (Large Scale Integration).

The control section 4 writes the four color image data generated by the image processing section 3 as image data of a bitmap format into a memory for each page. The bitmap data is the image data for printing.

The control section 4 outputs the image data for printing as four image signals to the image forming sections 5, 6, 7 and 8.

The control section 4 includes a CPU, a ROM, a RAM and an LSI. The ROM stores a control program. The control section 4 controls the whole operation of the color copier 1.

The CPU previously secures, in a RAM area, a voltage compensation table 4a (storage section) for storing a compensation secondary transfer bias value corresponding to a measured peak-to-peak value.

The image forming sections 5, 6, 7 and 8 generate images of K, C, M and Y, respectively.

The image forming section 5 includes a photoconductive drum 5a, a charging unit 5b, an exposure unit 5c and a developing unit 5d.

The photoconductive drum 5a is an image carrier which carries a black image on the outer peripheral surface of the photoconductive body.

The exposure unit 5c includes a laser light source, and irradiates an optical signal modulated by the image signal for black to the photoconductive drum 5a. The exposure unit 5c forms a black electrostatic latent image on the outer peripheral surface of the photoconductive drum 5a.

The developing unit 5d develops the electrostatic latent image on the outer peripheral surface of the photoconductive drum 5a with black toner.

When a not-shown motor rotates and drives a drum shaft, the photoconductive drum 5a starts to rotate.

The charging unit 5b charges the surface of the photoconductive drum 5a to a specified potential. The electrostatic latent image is formed on the surface by the modulated light from the exposure unit 5c.

The electrostatic latent image is developed with toner in a container of the developing unit 5d. A black development image is formed on the surface of the photoconductive drum 5a.

The image forming section 6 for a cyan image includes a photoconductive drum 6a, a charging unit 6b, an exposure unit 6c and a developing unit 6d. The image forming section 7 for a magenta image includes a photoconductive drum 7a, a charging unit 7b, an exposure unit 7c and a developing unit 7d. The image forming section 8 for an yellow image includes a photoconductive drum 8a, a charging unit 8b, an exposure unit 8c and a developing unit 8d.

The photoconductive drums 6a, 7a and 8a are substantially the same as the photoconductive drum 5a. The charging units 6b, 7b and 8b are substantially the same as the charging unit 5b. The exposure units 6c, 7c and 8c are substantially the same as the exposure unit 5c. The developing units 6d, 7d and 8d are substantially the same as the developing unit 5d.

The directions of the respective axes of the photoconductive drums 5a, 6a, 7a and 8a are parallel to each other.

The development images formed on the photoconductive drums 5a, 6a, 7a and 8a are transferred onto the intermediate transfer belt 9 so as to be superimposed in the order of Y, M, C and K.

After the intermediate transfer belt 9 passes the photoconductive drum 5a, the full-color toner image is formed on the intermediate transfer belt 9.

The intermediate transfer belt 9 is positioned below the photoconductive drums 5a, 6a, 7a and 8a, and faces and contacts with the photoconductive drums 5a, 6a, 7a and 8a.

The intermediate transfer belt 9 is endless and is held by a secondary transfer opposite roller 18 and other rollers 19a and 19b.

The secondary transfer opposite roller 18 backs up the intermediate transfer belt 9. The rollers 19a and 19b give a tension to the intermediate transfer belt 9.

A not-shown motor rotates and drives one of the secondary transfer opposite roller 18 and the rollers 19a and 19b. The intermediate transfer belt 9 is driven and controlled in an arrow direction by a friction force.

The intermediate transfer belt 9 has a laminated layer structure. The laminated layer includes layers of two or three kinds of conductive materials.

The intermediate transfer belt 9 is constructed by stacking a base material layer and an elastic layer.

Alternatively, the intermediate transfer belt 9 is constructed by stacking a base layer, an elastic layer and a surface layer.

A material stable in heat resistance and abrasion resistance is used for each layer.

As an example, the material of the base layer is a resin in which polyimide is a main ingredient and carbon is uniformly dispersed therein. The material of the elastic layer is silicone rubber or urethane rubber. The material of the surface layer is fluorine rubber.

The conductivity of the surface on which a toner image is placed is caused by electron conduction. The volume resistance value of the intermediate transfer belt 9 is within a range of 10⁸ Ωcm to 10⁹ Ωcm. The intermediate transfer belt 9 exhibits semiconductivity.

The primary transfer rollers 10, 11, 12 and 13 are provided at four positions opposite to the photoconductive drums 5a, 6a, 7a and 8a through the intermediate transfer belt 9. The four positions are primary transfer positions.

A not-shown power source applies primary transfer voltages to the primary transfer rollers 10, 11, 12 and 13. The polarity of the primary transfer voltage is opposite to the polarity of the toner image of each color. The control of the primary transfer voltage by the control section 4 is such that the output voltage of a power source is made constant at a certain voltage.

At a secondary transfer position, a secondary transfer roller 20 is opposite to the secondary transfer opposite roller 18. The secondary transfer opposite roller 18 and the secondary transfer roller 20 constitute the secondary transfer section 15 (transfer section).

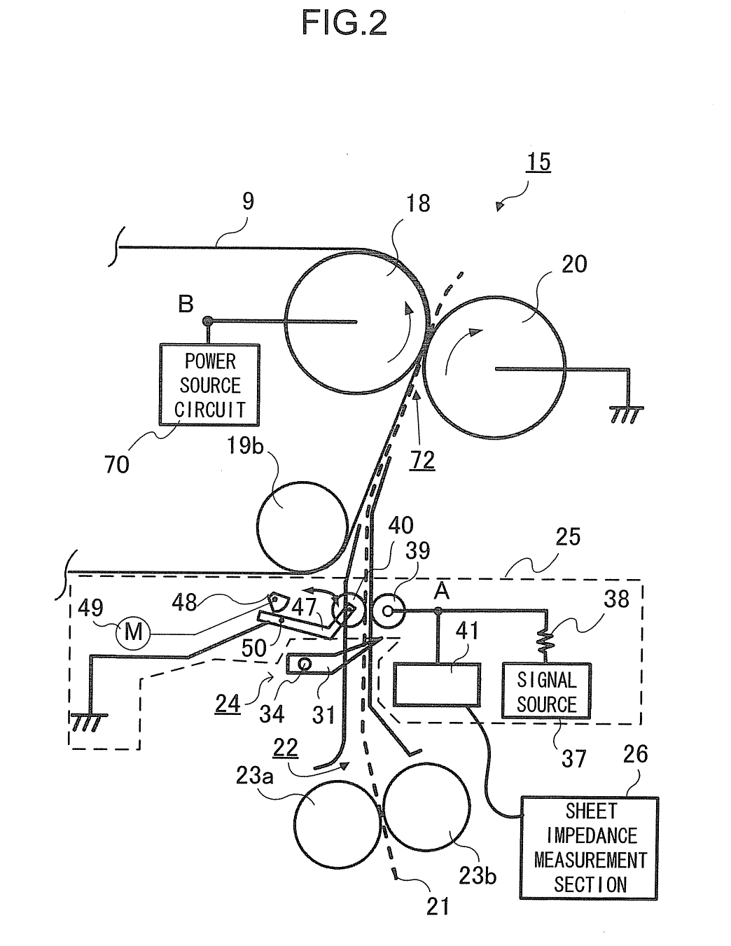

FIG. 2 is an enlarged view of the secondary transfer section 15. In the drawing, the same reference numeral as the previously-mentioned reference numeral denotes the same component.

The secondary transfer roller 20 includes, for example, a metal shaft, a conductive elastic member covering the outer peripheral surface of the shaft, and a surface layer covering the surface of the elastic member.

The shaft is electrically grounded to a ground potential. The elastic member is a sponge made of rubber, or the like. In the first embodiment, semiconductive polyimide resin is used as the material of the surface layer.

The secondary transfer opposite roller 18 is the roller made of aluminum. The secondary transfer opposite roller 18 is connected to a power source circuit 70 (transfer bias supply section) to output a secondary transfer bias. The control section 4 controls the power source circuit 70.

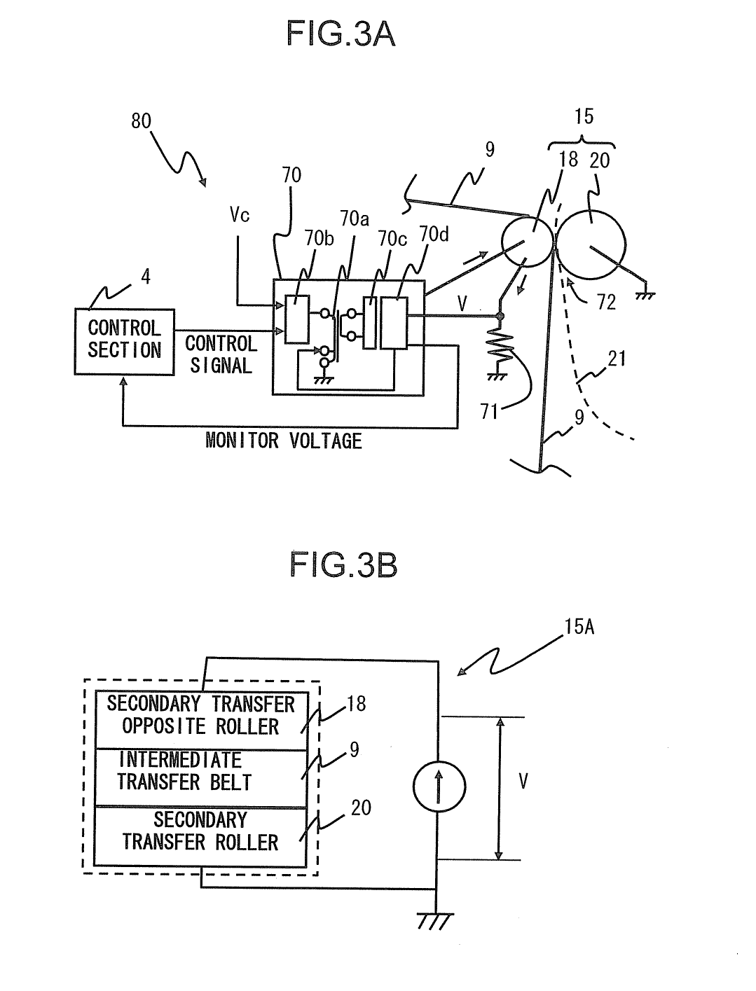

FIG. 3A is a view showing an example of the secondary transfer bias control system including the power source circuit 70. In the drawing, the same reference numeral as the previously-mentioned reference numeral denotes the same component.

A secondary transfer bias control system 80 causes the value of output current from the power source circuit 70 to the secondary transfer opposite roller 18 to become constant at a certain current value.

The power source circuit 70 includes, as an example, a transformer 70a, a switch circuit 70b at the primary side of the transformer 70a, a rectifier circuit 70c at the secondary side of the transformer 70a, and a bias circuit 70d.

A not-shown resonant circuit is connected to the primary side of the transformer 70a.

The switch circuit 70b includes a switching transistor. The switch circuit 70b excites or de-excites the resonant circuit by the on or off instruction from the control section 4.

By the on or off operation of the switch circuit 70b, the transformer 70a outputs an AC voltage signal obtained by converting a DC voltage Vc supplied from a not-shown DC voltage source or the like.

The rectifier circuit 70c rectifies the AC voltage signal outputted in that way.

The bias circuit 70d generates a constant current from the rectified voltage signal and outputs it. This constant current functions as a bias for detecting the resistance of the secondary transfer section 15 when there is no sheet. The bias circuit 70d includes an amplifier circuit and a sample hold circuit.

The bias circuit 70d can supply the constant current of, for example, about −30 μA to the secondary transfer opposite roller 18.

A resistor 71 is connected between the return side of the secondary transfer opposite roller 18 and the ground. The impedance of the resistor 71 is larger than the impedance of the power source circuit 70.

The bias circuit 70d detects a voltage at a middle point between the resistor 71 and the secondary transfer opposite roller 18.

FIG. 3B shows an equivalent circuit of the secondary transfer section 15. In an equivalent circuit 15A, the constant current is applied.

The bias circuit 70d detects the potential difference V between both ends of the secondary transfer roller 20, the intermediate transfer belt 9 and the secondary transfer opposite roller 18 which are connected in series to each other.

The bias circuit 70d waits for a specified time until the current becomes stable by the control of the control section 4, and outputs the detected voltage as a monitor voltage. The monitor voltage is notified to the control section 4 and is used to compensate the transfer bias.

Besides, the power source circuit 70 has also a function to perform constant voltage control of the secondary transfer opposite roller 18, and uses the voltage detected by the constant current control when there is no sheet and performs application of a bias of a constant voltage when toner is actually transferred. In this case, the control of the control section 4 on the power source circuit 70 is performed such that both the current and voltage can be made constant.

At the secondary transfer position of FIG. 2, the control section 4 controls the voltage so that the current flowing through the secondary transfer opposite roller 18 and a sheet 21 becomes constant.

The polarity of the secondary transfer voltage applied to the secondary transfer opposite roller 18 is the same as the polarity of the potential of the toner image of each color. For example, when the charging polarity of the toner is plus, the control section 4 applies a plus bias to the secondary transfer opposite roller 18.

The sheet 21 is a recording medium. As the recording medium, a thick paper, a thin paper, or an OHP (overhead projector) sheet is used.

The sheet 21 reaches a transfer nip 72 between the intermediate transfer belt 9 and the secondary transfer roller 20.

The transfer nip 72 is a surface area formed when the outer peripheral surface of the secondary transfer roller 20 contacts with the surface of the intermediate transfer belt 9 on which the toner image is carried. The transfer nip 72 has a specified width in a circumferential direction.

When the sheet 21 is passing through the transfer nip 72, the toner image on the intermediate transfer belt 9 is moved onto the sheet 21.

A conveyance path 22 for conveyance of the sheet 21 is defined between an outlet of the sheet feed cassette 14 of FIG. 1 and the storage tray 17. The conveyance path 22 is provided with a pair of register rollers 23a and 23b.

The fixing unit 16 includes a roller 16a to apply pressure to the sheet 21 and a roller 16b to apply heat to the sheet 21.

The toner image is fixed on the sheet 21 when the sheet 21 is passing through between the rollers 16a and 16b in the state where the toner image contacts with the roller 16b. The sheet 21 is discharged from the storage tray 17 to the outside of the machine.

In the first embodiment, the color copier 1 includes a switch 24, a Vpp measurement section 25 and a sheet impedance measurement section 26.

The switch 24 detects the passing of the sheet 21.

The switch 24 is positioned downstream of the register rollers 23a and 23b and upstream of the Vpp measurement section 25 on the conveyance path 22. The upstream and the downstream indicate a direction in which the sheet 21 is conveyed and a direction opposite to the direction.

The switch 24 detects the leading edge and the trailing edge of the sheet 21 moving from below to above. The switch 24 is electrically connected to the control section 4. The control section 4 monitors the state of the switch 24, and detects the passing of the sheet 21 when the state is changed.

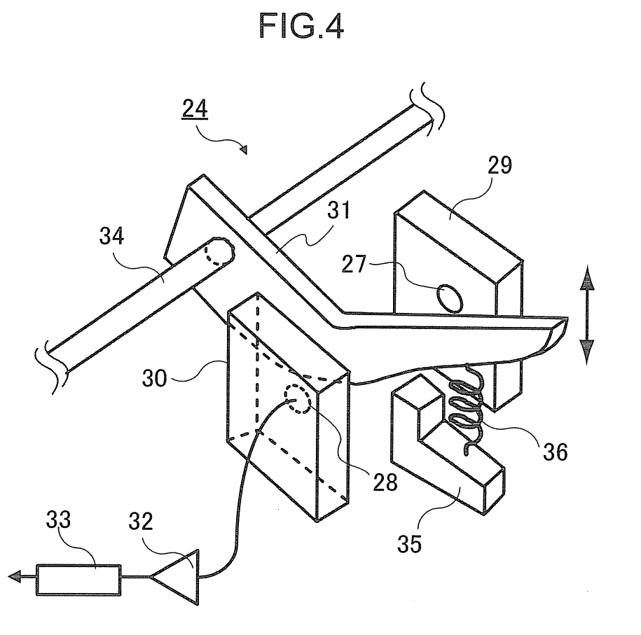

FIG. 4 is a perspective view of the switch 24. The same reference numeral as the previously-mentioned reference numeral denotes the same component.

The switch 24 includes, for example, a light source 27, a photodiode 28, and a support member 29 provided with the light source 27 on its side surface.

The switch 24 further includes a support member 30 provided with the photodiode 28 on its side surface, and a lever 31 which is displaced between a first position where light is allowed to pass through and a second position where light is shielded.

The photodiode 28 is provided in an area of the side surface of the support member 30 which is irradiated with the light from the light source 27.

The first position is a non-detection position where the lever 31 is off the light path from the light source 27 to the photodiode 28. The second position is a detection position where the light from the light source 27 to the photodiode 28 is shielded.

Further, the switch 24 includes an amplifier 32 to amplify an electric signal outputted from the photodiode 28, and a logical circuit 33 to output a signal expressing detection or non-detection according to the output of the amplifier 32.

The signal outputted from the logical circuit 33 distinguishes a state after the sheet 21 is detected and a state where the sheet 21 is not detected.

One end of the lever 31 is supported through bearings by a rod-like support shaft 34 extending in a thrust direction. The other end of the lever is a free end. An interference member 35 is provided below the lever 31. The interference member 35 is fixed to a frame of the machine.

When the sheet 21 is not conveyed on the conveyance path 22, the lever 31 is pulled by an elastic force of a spring 36 or the like in a state where the lever 31 in the longitudinal direction is inclined by the interference member 35. The lever 31 is stopped at the non-detection position.

When the sheet 21 is conveyed on the conveyance path 22, the other end of the lever 31 is pressed upward by the leading edge of the sheet 21.

The lever 31 is rotated from the non-detection position to the detection position, and shields the light from the light source 27. In response to the output from the photodiode 28, the logical circuit 33 outputs a signal indicating the detection of the sheet 21 to the control section 4.

The leading edge of the sheet 21 presses the lever 31, so that the lever 31 is moved from the non-detection position to the detect position. The control section 4 detects the passing of the leading edge of the sheet 21.

When the trailing edge of the sheet 21 comes off from the lever 31 and the lever 31 is returned from the non-detection position to the detection position, the control section 4 detects the passing of the trailing edge of the sheet 21.

The Vpp measurement section 25 of FIG. 2 measures the peak-to-peak amplitude of the AC voltage at point A. That is, the Vpp measurement section 25 measures Vpp at the point A.

The Vpp measurement section 25 is positioned downstream of the switch 24 and upstream of the secondary transfer section 15 on the conveyance path 22.

The Vpp measurement section 25 includes a signal source 37, a resistor 38, a pair of detection rollers 40 and 39 (electrode pair), and a voltage detection circuit 41.

The signal source 37 outputs a rectangular pulse signal. The resistor 38 is a protective resistor, and an electric resistance element is used.

The detection rollers 40 and 39 are conductive electrode rollers. The detection rollers 40 and 39 are metal rollers. The outer peripheral surfaces of the detection rollers 40 and 39 are opposite to each other.

The detection rollers 40 and 39 are provided upstream of the secondary transfer roller 20 in the conveyance direction of the sheet 21. The detection rollers 40 and 39 nip the sheet 21 and apply the AC bias to the sheet 21.

The roller surface of the detection roller 40 is coated with the same material as the material of the base layer of the intermediate transfer belt 9. The material of the roller surface of the detection roller 40 is semiconductive polyimide.

The roller surface of the detection roller 39 is coated with the same material as the material of the outer peripheral surface of the secondary transfer roller 20. The material of the roller surface of the detection roller 39 is also semiconductive polyimide.

The resistance value of each of the roller surface layers of the detection rollers 40 and 39 is within a range of 10⁸ Ωcm to 10⁹ Ωcm.

The detection rollers 40 and 39 can contact with and can be separated from the sheet 21. The detection rollers 40 and 39 have a function to nip the sheet 21 and a function as an electrode to which a bias is applied.

Semiconductive polyimide has a characteristic that a change in resistance value with respect to an environmental change is small.

Since polyimide having the electrically stable characteristic is used, the color copier 1 is enabled to measure a stable resistance or impedance of the sheet 21.

When the sheet 21 as a load is electrically connected to the signal source 37, the impedance when the ground is viewed from the signal source 37 is equal to a synthetic impedance obtained when the resistor 38 and the sheet 21 are connected serially.

The Vpp measurement section 25 measures the impedance of the sheet 21 in the state where the detection rollers 40 and 39 nip the sheet 21.

The voltage detection circuit 41 detects the peak value of an alternating AC voltage.

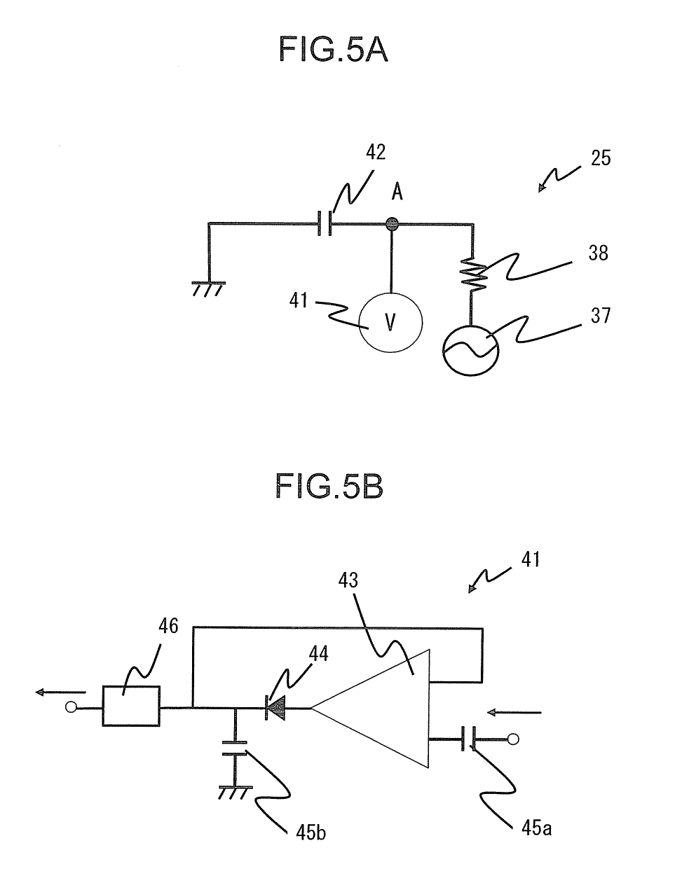

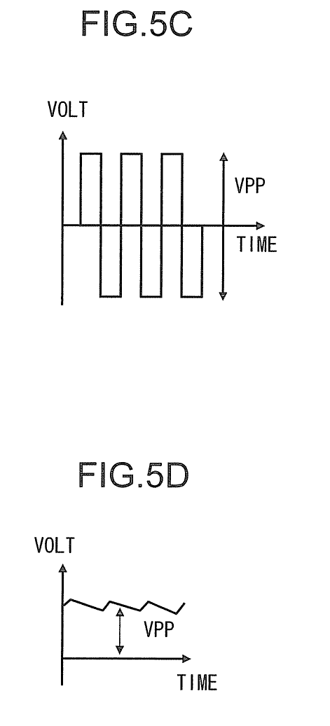

FIG. 5A is a view showing an equivalent circuit of the Vpp measurement section 25. In the drawing, the same reference numeral as the previously-mentioned reference numeral denotes the same component.

When a dominant factor to determine the impedance of the sheet 21 is a capacitance, the Vpp measurement section 25 is expressed by the equivalent circuit including a capacitor 42. The capacitance of the capacitor 42 is determined by an experiment.

FIG. 5B is a view showing an example of the voltage detection circuit 41. FIG. 5C is a view showing a waveform of a signal inputted to the voltage detection circuit 41. FIG. 5D is a view showing a waveform of a signal outputted from the voltage detection circuit 41. In these drawings, the same reference numeral as the previously-mentioned reference numeral denotes the same component.

The voltage detection circuit 41 includes a comparator 43, a diode 44, capacitors 45a and 45b, and an analog-digital converter 46.

A signal is inputted to one input terminal of the comparator 43 through the capacitor 45a. The time waveform of the signal is changed as shown in, for example, FIG. 5C.

When the signal level is positive, the diode is ON. An electric charge is stored in the capacitor 45b, and the voltage of the capacitor 45b is raised. The capacitor 45b indicates a higher peak voltage value.

The voltage of the capacitor 45b is fed back and inputted as a reference voltage to the other input terminal of the comparator 43.

When the level of the input signal to the voltage detection circuit 41 is negative, the diode 44 is OFF. The voltage of the capacitor 45b still indicates the peak voltage value.

When the peak voltage Vpp is higher than the reference voltage, the anode side voltage of the diode 44 is low.

A bias current to the capacitor 45b is decreased. When the peak voltage Vpp is lower than the reference voltage, the bias current is increased.

As a result, the voltage detection circuit 41 integrates the input signal. As shown in FIG. 5D, the voltage detection circuit 41 outputs the peak voltage Vpp.

The analog-digital converter 46 performs AD conversion of the peak voltage Vpp, and outputs the digital value obtained by the conversion.

Besides, in FIG. 2, the sheet impedance measurement section 26 is connected to the voltage detection circuit 41. The sheet impedance measurement section 26 is a characteristic detection section.

The sheet impedance measurement section 26 detects an electric characteristic value of the sheet 21 when the detection rollers 40 and 39 apply the AC bias, that is, an impedance.

The sheet impedance measurement section 26 includes a CPU, a ROM and a RAM. The ROM previously stores information of the signal level of the signal from the signal source 37, and the periodic frequency of the signal. Alternatively, the information is notified from the control section 4 and is stored.

The sheet impedance measurement section 26 reads the Vpp value of the signal source 37 from the memory, and calculates the impedance of the sheet 21 based on this Vpp value and the digital Vpp value from the voltage detection circuit 41.

The sheet impedance measurement section 26 notifies a calculation result to the control section 4.

The measurement function of the sheet impedance may be installed in the control section 4.

The Vpp measurement section 25 of FIG. 2 further includes an arm 47, a cam 48 and a motor 49 for driving the cam 48.

The arm 47 has conductivity and is grounded to the ground potential. The arm 47 has a bent part. A spring or the like exerts a downward force on the bent part.

One end of the arm 47 is supported through bearings by the detection roller 40. The other end of the arm 47 contacts with the cam 48. The eccentric cam 48 is rotated by the motor 49. The control section 4 controls the rotation of the motor 49.

An intermediate part of the arm 47 is supported through bearings by a support shaft 50 extending in a thrust direction. Both ends of the arm 47 are moved like a seesaw about the shaft core of the support shaft 50 by the rotation of the cam 48.

When the other end of the arm 47 is pressed downward, the one end of the arm 47 is pressed upward. The same applies to the case where the movement of the arm 47 is in the opposite direction.

The detection rollers 40 and 39, the arm 47, the cam 48 and the motor 49 of the Vpp measurement section 25 constitute a mechanism to nip the sheet 21. The mechanism nips the sheet 21, and releases the nipping of the sheet 21. The control section 4 controls the operation of the mechanism.

The operation of the color copier 1 of the above structure will be described.

First, before the sheet 21 reaches the transfer nip 72, the control section 4 causes the secondary transfer roller 20 to contact with the intermediate transfer belt 9, and instructs the power source circuit 70 to supply a current of a specified value to the transfer nip 72. The current value is determined according to, for example, the sheet conveyance speed.

The control section 4 causes the circuit in the power source circuit 70 to detect a voltage V at point B in FIG. 2. The control program causes the CPU to calculate transfer voltage A by substituting the voltage V into a circuit equation or the like.

By the calculation of the CPU, the control section 4 acquires the transfer voltage A in the case where the sheet 21 does not exist. The CPU stores the transfer voltage A in the RAM.

That is, the color copier 1 includes the mechanism to detect the electric characteristic value of the transfer member constituting the secondary transfer section 15, and the control section 4 uses the electric characteristic value to compensate the transfer bias value. The secondary transfer roller 20 and the secondary transfer opposite roller 18 are transfer members to constitute the secondary transfer section 15.

The control section 4 starts the execution of a color print process.

The primary transfer rollers 10, 11, 12 and 13 sequentially transfer toner images of respective colors on the photoconductive drums 5a, 6a, 7a and 8a to the intermediate transfer belt 9.

The control section 4 instructs the mechanism of conveying the sheet 21 to start the operation.

The register rollers 23a and 23b convey the sheet 21. The switch 24 outputs a signal indicating the state of the switch 24 to the control section 4.

The control section 4 counts whether the time of a previously held timer value passes since the signal is notified from the switch 24. The control section 4 detects whether or not the sheet 21 passes.

When the initial state is the state where light is detected, when the control section 4 determines that the time in which light is shielded is longer than a specified time, the control section 4 detects the existence of the sheet 21.

In the state where the existence of the sheet 21 is detected, when the control section 4 determines that light is again detected, the control section 4 detects that the passing of the sheet 21 is finished.

After a specified time passes since the control section 4 detects the existence of the sheet 21, the control section 4 operates the mechanism to nip the sheet 21. The time is determined according to the distance between the switch 24 and the Vpp measurement section 25, the delay at the start of the motor, and the like.

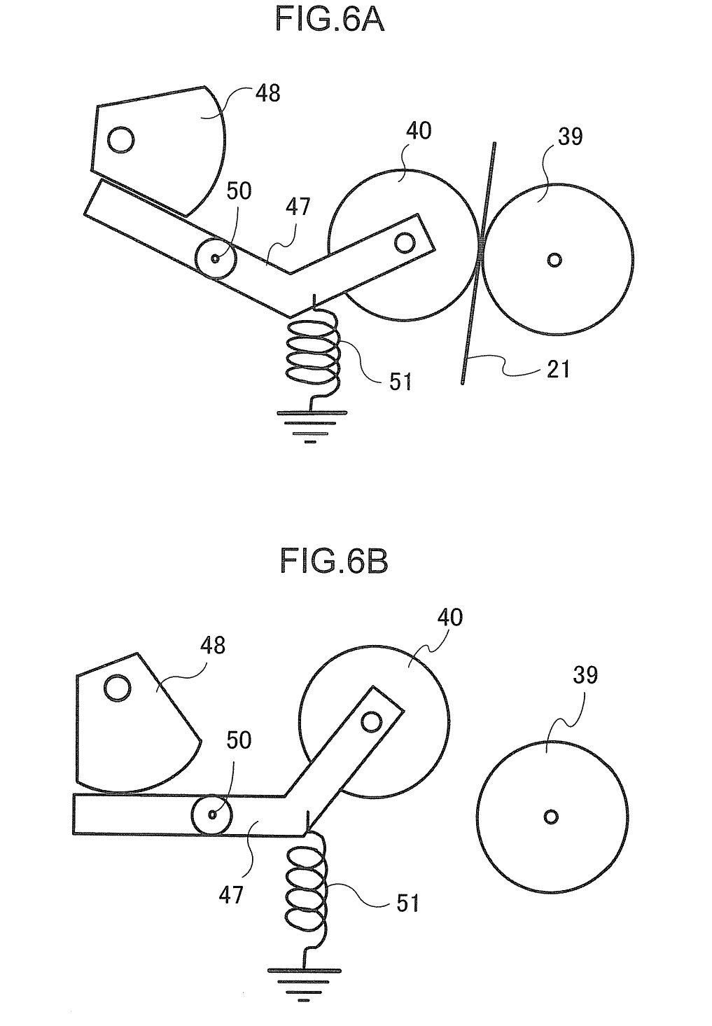

FIG. 6A is a view showing the mechanism to nip the sheet 21 and a state where the sheet 21 is being nipped. FIG. 6B is a view showing the mechanism to nip the sheet 21 and a state where the sheet 21 is released.

The figures show the mechanism viewed from the front side of the machine. Reference numeral 51 denotes a spring. The same reference numeral as the previously-mentioned reference numeral denotes the same component.

The control section 4 causes the detection roller 39 to apply the bias to the sheet 21.

In FIG. 6A, the other end of the arm 47 is raised by the rotation of the cam 48, and the arm 47 rotates around the support shaft 50 as a fulcrum.

The detection roller 40 is displaced rightward, and the detection roller 40 contacts with the sheet 21. The sheet 21 is pressed to the outer peripheral surface of the detection roller 39.

The material of the roller surface of the detection roller 40 of the roller pair is semiconductive polyimide. The roller material of the detection roller 39 is the same as the material of the surface of the secondary transfer roller 20 of the secondary transfer section 15, and is also semiconductive polyimide in this embodiment.

The detection roller 40 corresponding to the intermediate transfer belt 9 contacts with one surface of the front and back surfaces of the sheet 21. The detection roller 39 corresponding to the secondary transfer roller 20 contacts with the other surface.

The control section 4 already acquires the transfer voltage A from the feedback value in the state where the sheet 21 does not exist in the secondary transfer section 15.

With respect to the transfer voltage A obtained by the secondary transfer section 15 when the sheet 21 does not exist, and the transfer voltage B to be obtained when the sheet 21 exists between the detection rollers 40 and 39, the rollers of the same surface material are used.

The control section 4 can obtain the resistance values of the detection rollers 40 and 39 or the information relating to the resistance value from the information of the bias at the time of acquisition of the transfer voltage A.

The point that the polyimide resin is used as the surface material will be further described.

The electric characteristic of the sheet 21 is changed by a humidity environment. Under the high humidity environment, the sheet 21 is liable to be wetted. The volume resistivity of the wet sheet 21 is reduced.

It is desirable that the change amount of the volume resistivity of the surface material of the detection rollers 40 and 39 is smaller than the change amount of the volume resistance value of the sheet 21. Alternatively, it is desirable that the volume resistance value of the surface material of the detection rollers 40 and 39 is not changed with the humidity change.

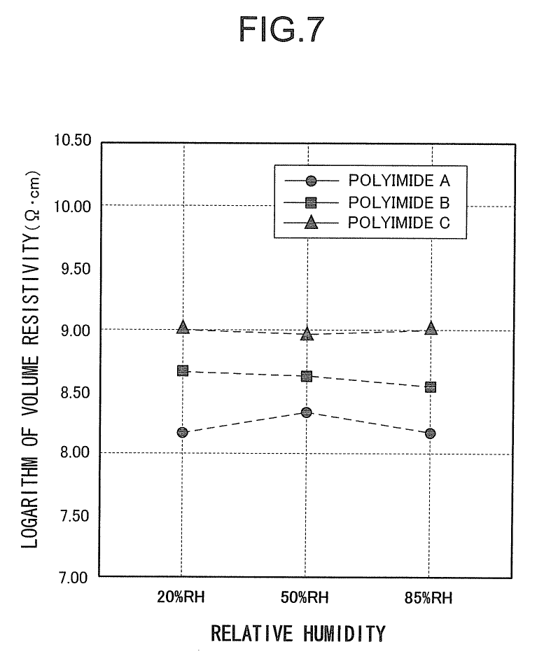

FIG. 7 shows an example of the characteristic of the volume resistivity of the surface material to the relative humidity when semiconductive polyimide resin is used as the surface material of the detection rollers 40 and 39.

The relative humidity indicates a value expressed in percentage of the ratio of the amount of water vapor contained in a specific volume to the amount of saturated water vapor in the air.

FIG. 7 is a diagram showing humidity characteristics of volume resistivities of surface materials of three kinds of polyimide resins. The figure shows the characteristics of the volume resistance of polyimide resins A, B and C having three levels of volume resistance values.

As shown in FIG. 7, each of the polyimide resins having the three levels of volume resistance values has a small amount of change relative to the humidity change and is stable.

On the other hand, the not-shown sheet 21 has a characteristic that the amount of change in volume resistance value is large within the range of 20% to 85% of the relative humidity. The polyimide resin is excellent for an electrode to measure the impedance of the sheet 21.

The important point is that in the example of FIG. 7, the electric characteristic of the polyimide resin is preferable as the surface material for detecting the electric characteristic of the sheet 21.

The measurement for obtaining the characteristics of the figure is performed under the following condition. A measuring device of the resistivity is a high resistivity meter Highrestor (registered trademark)-IP made by Mitsubishi Petrochemical Co., Ltd. An HR-SS probe is connected to the measuring device. A voltage of +500 V is applied to a sample.

The control section 4 causes the detection roller 40 to apply an AC bias signal to the signal source 37 through the resistor 38 of 10 MΩ.

The peak-to-peak voltage is measured when the sheet 21 is being nipped between the detection roller 40 and the detection roller 39.

The frequency of the AC bias signal is 1 kHz. The peak-to-peak value of the AC bias signal is 1 kV. The waveform of the AC bias signal has a value within the range of +500 V to −500 V.

The control section 4 causes the voltage detection circuit 41 to detect the peak-to-peak voltage at the point A. The sheet impedance measurement section 26 measures the impedance of the sheet 21, and notifies the measurement value to the control section 4.

In this way, the electric characteristic corresponding to the impedance of the sheet 21 is measured by the application of the bias.

The control section 4 refers to the voltage compensation table 4a based on the detected peak-to-peak voltage and converts it into a compensation voltage B.

The voltage compensation table 4a correlates the characteristic value of the sheet 21a with the transfer bias value. The voltage compensation table 4a stores the peak-to-peak voltage value as the characteristic value.

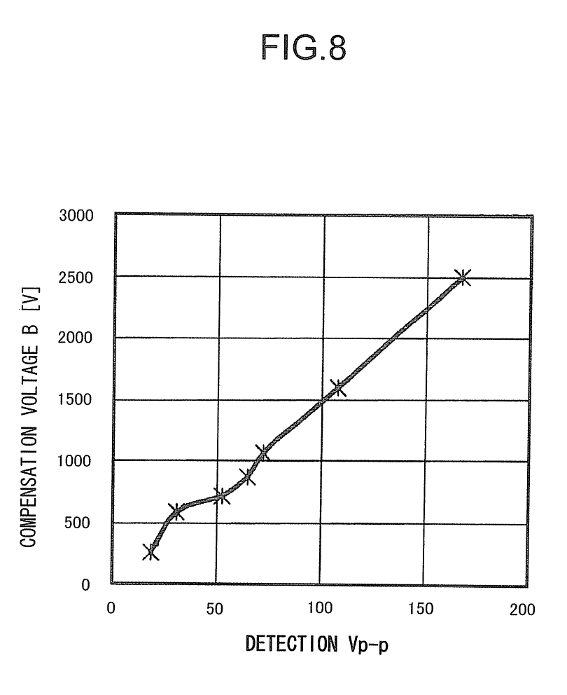

FIG. 8 is a view showing an example of data stored in the voltage compensation table 4a. The table data shows a corresponding relation between the voltage before the conversion and the voltage after the conversion.

The control section 4 reads the compensation voltage B corresponding to the peak-to-peak voltage value detected by the sheet impedance measurement section 26 from the voltage compensation table 4a. The control section 4 uses the secondary transfer voltage value and compensates the output bias value from the power source circuit 70.

Specifically, the control section 4 determines the compensation voltage B by interpolation calculation from the data relation shown in FIG. 8.

As shown by multiplication marks of the figure, the relation between the detected voltage Vpp and the secondary transfer roller compensation voltage is previously stored as seven records in the voltage compensation table 4a. The data of the relation is obtained by an experiment of the present inventor.

The control section 4 reads plural records having values close to the detected Vpp value from the voltage compensation table 4a. The control section 4 obtains the compensation voltage B(V) by a linear interpolation algorithm.

The control section 4 adds the transfer voltage A obtained by flowing the constant current to the transfer nip 72 when the sheet 21 does not exist to the compensation voltage B obtained by using the detection rollers 40 and 39. The control section 4 determines the voltage obtained by the addition as the final transfer bias.

The control section 4 notifies the value of the determined transfer bias to the power source circuit 70.

The power source circuit 70 applies the notified bias to the secondary transfer opposite roller 18.

When the sheet 21 reaches the transfer nip 72, the transfer bias is applied from the secondary transfer opposite roller 18 to the sheet 21.

Subsequently, the sheet 21 is conveyed to the fixing unit 16. The fixing unit 16 fixes the toner image to the sheet 21. The sheet 21 is conveyed to the storage tray 17 and is discharged to the outside of the machine.

By doing so, the transfer bias having the optimum value corresponding to the electric characteristic of the sheet 21 can be applied. The optimum bias is applied to the sheet 21 according to the characteristic of the sheet 21 changed by humidity.

When the Vpp measurement section 25 applies a constant DC bias to the sheet 21 to know the electric characteristic of the sheet 21, the sheet 21 is charged positively or negatively. The sheet 21 charged positively or negatively is moved to the secondary transfer section 15.

In this case, there is a fear that the secondary transfer bias becomes excessive by the charge amount of the sheet 21. When an excessive amount of electric charge is accumulated on the sheet 21, an electric discharge is generated in the transfer nip 72. An image on the sheet 21 is disturbed.

In the color copier 1 including the image forming apparatus of the first embodiment, the polarity of the AC bias signal is alternately changed. The amount of electric charge on the sheet 21 is not increased. An excessive DC bias is not applied to the sheet 21.

In the color copier 1, since the AC bias signal is applied to the sheet 21, the electric discharge is not generated in the transfer nip 72. An image on the sheet 21 becomes stable.

Although the resistance value of the secondary transfer roller 20 may be changed by the change of humidity, the transfer bias is compensated in the color copier 1 by the transfer voltage A measured immediately before the secondary transfer.

In the first embodiment, even if the resistance value of the secondary transfer roller 20 is changed, a suitable bias can be applied according to the change. The transfer device resistant to the environmental change can be realized.

As described above, the physical values relating to not only the secondary transfer roller constituting the transfer device but also the recording medium are measured and reflected in the transfer bias, and the excellent transfer property can be obtained.

Incidentally, since the surface material of the roller electrode has a certain degree of resistance, the possibility of electrical short-circuit is removed.

With respect to the detection roller 40 of the roller electrodes, the same material as the material used for the intermediate transfer belt 9 is used. With respect to the detection roller 39, the same material as the material used for the secondary transfer roller 20 is used. Even when the resistive member of the electrode surface of the roller electrode is changed by the environment, it becomes possible to distinguish between the influence by the resistance change of the sheet 21 and the influence by the resistance change of the roller electrode surface.

### Modified Example of the First Embodiment

When the time elapsed before the sheet 21 reaches the transfer nip 72 is short, there is a case where time required for the detection of the impedance of the sheet 21 by the sheet impedance measurement section 26 can not be sufficiently taken.

An image forming apparatus of a modified example of the first embodiment has a function to select whether or not the process of detecting the sheet impedance is executed.

The control section 4 of FIG. 1 includes an execution propriety selection section 4b. The execution propriety selection section 4b selectively switches between turning-on and turning-off of an operation of detecting the impedance of the sheet 21.

In the control of the execution propriety selection section 4b, for example, the detection operation is turned off in a normal mode, and the detection operation is turned on at the time of start of the machine. The condition of the switching is described in a program code of the ROM.

The control section 4 detects setting information from a not-shown user interface panel and may control the switching.

The control program of the control section 4 previously incorporates a scheme to decrease the process speeds and the print speeds of the four image forming sections 5, 6, 7 and 8 only at the time of an impedance detection mode.

The structure of the image forming apparatus of the modified example other than these is substantially the same as that of the first embodiment.

When the color copier 1 having the structure as stated above is started, the control section 4 sets the mode of the machine to a sheet impedance detection mode. The color copier 1 operates in the sheet impedance detection mode.

The control section 4 detects the impedance of the sheet 21. After the detection, the control section 4 returns the mode of the machine to the normal mode.

The control section 4 causes the process speed of the image forming sections 5, 6, 7 and 8 when the process of detecting the impedance of the sheet 21 is on to become lower than the process speed of the image forming sections 5, 6, 7 and 8 when the process is off.

When the impedance detection mode of the sheet 21 is selected, the time required for detection of the impedance of the sheet 21 can be sufficiently taken.

The switch 24, the Vpp measurement section 25 and the sheet impedance measurement section 26 are operated by the instruction in the impedance detection mode.

The secondary transfer section 15 can apply the optimum secondary transfer bias to the sheet 21 according to the humidity or the like. The picture quality can be improved.

In the impedance detection mode, after the sheet impedance measurement section 26 measures the impedance, the control section 4 again causes the machine to operate in the normal mode.

The print speed in the normal mode is higher than the print speed in the impedance detection mode.

According to the image forming apparatus of the modified example, one of the picture quality and the print performance can be made to precede.

Especially, when more importance is given to the print performance than the picture quality, and the color copier 1 executes the process, the execution of the sheet impedance detection mode is turned off, so that the print speed can be increased.

The process speed of the color copier 1 when the impedance detection control of the sheet 21 is ON is lower than the process speed when the impedance detection control is OFF.

That is, the print time per one sheet with compensation of the transfer bias is longer than the print time per one sheet without compensation of the transfer bias.

The execution of the sequence to compensate the bias by feeding back the measurement value of the impedance and the increase of the production number of printed materials are in trade-off.

In the image forming apparatus of the modified example, the convenience for the user is improved by providing the function to select the necessity of the compensation of the transfer bias.

Besides, also in the modified example, the surface materials of the detection rollers 40 and 39 are respectively the same as the surface materials of the intermediate transfer belt 9 and the secondary transfer roller 20. The sheet impedance measurement section 26 can also stably measure the impedance.

Besides, by using an elastic body as the surface material of one of the detection rollers 40 and 39, the nip between the sheet 21 and the detection rollers 40 and 39 can be ensured.

In this case, the width of the nip by the contact between the detection roller 40 and the sheet 21 and the width of the nip by the contact between the detection roller 39 and the sheet 21 are widened. The area of the nip is increased.

Since the nip is stabilized, the measurement accuracy of the impedance of the sheet 21 can be stabilized.

### Second Embodiment

The image forming apparatus of the first embodiment is the apparatus using the intermediate transfer belt system, and is the example of the case where the toner image on the intermediate transfer belt 9 is transferred to the sheet 21. In an image forming apparatus of a second embodiment, an image on a photoconductive body is directly transferred to a recording medium.

The image forming apparatus of the second embodiment is a monochrome copier or a color copier.

The monochrome copier of a direct transfer system includes an image forming section for black. The image forming section for black includes one photoconductive drum, one charging device, one exposure device and one developing device.

The color copier of the direct transfer system includes a color image forming section. The color image forming section includes, for example, one photoconductive drum, four charging devices, four exposure devices and four developing devices.

The image forming apparatus of the second embodiment can be applied to both the monochrome copier and the color copier. In the second embodiment, the monochrome copier will be described unless otherwise stated.

A transfer bias compensation method of the image forming apparatus of the second embodiment is a method in which a control program installed in the monochrome copier causes a transfer device to compensate a transfer bias.

In the second embodiment, the description of the first embodiment except that the member to which the toner image is transferred is the photoconductive drum instead of the intermediate transfer belt 9 can be applied to the transfer bias compensation method.

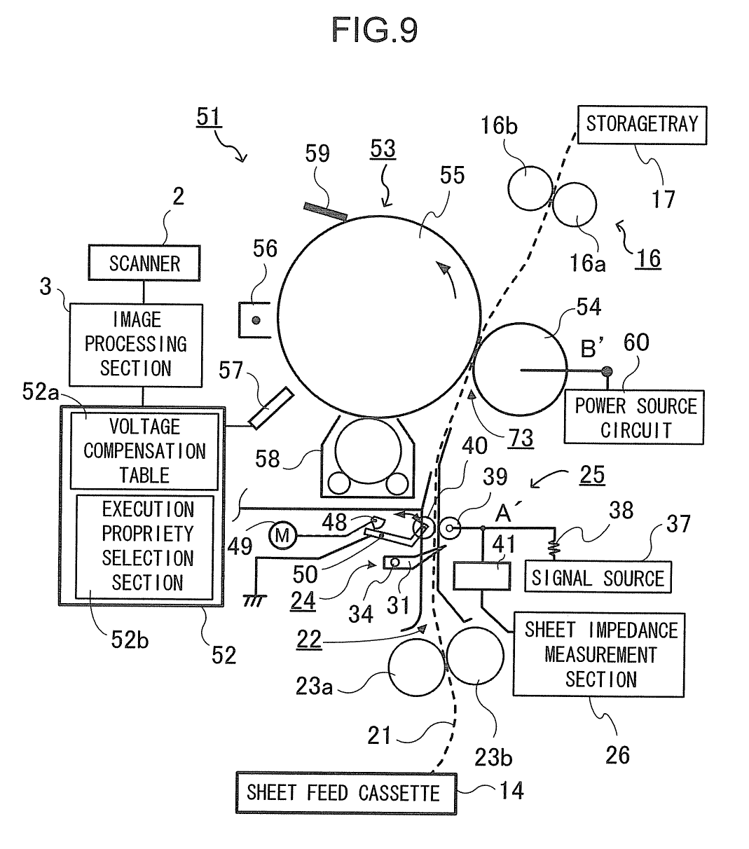

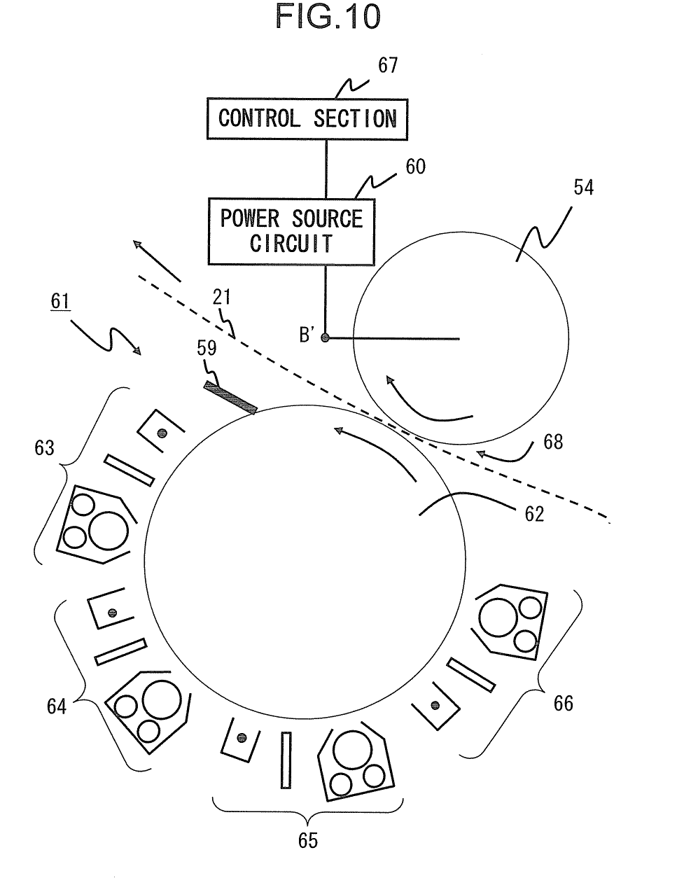

FIG. 9 is a structural view of the monochrome copier including the image forming apparatus of the second embodiment. In the drawing, the same reference numeral as the previously-mentioned reference numeral denotes the same component.

A monochrome copier 51 includes a scanner 2, an image processing section 3, a control section 52, an image forming section 53 and a transfer roller 54.

The control section 52 outputs monochrome image data generated by the image processing section 3 as an image signal for printing to the image forming section 53. The control section 52 controls the whole operation of the monochrome copier 51.

The control section 52 includes a CPU, a ROM, a RAM and an LSI.

The control section 52 includes, in a RAM area, a voltage compensation table 52a for storing a compensation transfer bias value and an execution propriety selection section 52b for selecting whether or not the process of detecting a sheet impedance is to be executed.

The image forming section 53 includes a photoconductive drum 55, a charging unit 56, an exposure unit 57, a developing unit 58 and a blade 59.

The respective functions of the photoconductive drum 55, the charging unit 56, the exposure unit 57 and the developing unit 58 are substantially the same as the functions of the photoconductive drum 5a, the charging unit 5b, the exposure unit 5c and the developing unit 5d of the first embodiment.

The blade 59 is provided to contact with the outer peripheral surface of the photoconductive drum 55. The blade 59 peels off the toner remaining on the outer peripheral surface after the end of transfer of the toner image.

The transfer roller 54 is provided to face the image forming section 53.

The transfer roller 54 (transfer device) transfers the toner image on the outer peripheral surface of the photoconductive drum 55 to the sheet 21. The transfer roller 54 can contact with the photoconductive drum 55 and can be separated from the photoconductive drum 55.

The transfer roller 54 includes a metal shaft, a conductive elastic member covering the outer peripheral surface of the shaft, and a surface layer covering the surface of the elastic member.

A power source circuit 60 applies a bias to the shaft. The power source circuit 60 is electrically connected to the control section 52, and is notified of the bias value by the control section 52.

For example, a rubber sponge is used for the elastic member. Solid elastic rubber of the same material as the sponge is used for the surface layer.

Further, the monochrome copier 51 includes a sheet feed cassette 14, a fixing unit 16, a storage tray 17, a switch 24, a Vpp measurement section 25 and a sheet impedance measurement section 26.

The structures of the switch 24, the Vpp measurement section 25, and the sheet impedance measurement section 26 are the same as the foregoing structures of these.

In the second embodiment, the roller surface of the detection roller 40 is coated with semiconductive polyimide.

When an organic photoconductive material is used for the photoconductive drum 55, the photoconductive drum 55 includes, for example, an aluminum drum and plural layers coaxially provided on the outer peripheral surface of the drum. The plural layers are layers for the generation and transport of electric charges.

The roller surface of the detection roller 39 is coated with substantially the same material as the material of the outer peripheral surface of the transfer roller 54.

The operation of the monochrome copier 51 of the foregoing structure will be described.

First, the charging unit 56 uniformly charges the photoconductive drum 55.

The control section 52 causes the transfer roller 54 to contact with the photoconductive drum 55, and causes the power source circuit 60 to apply a constant current to a transfer nip 73.

The control section 52 causes the power source circuit 60 to detect a voltage V at point B′ in FIG. 9.

The control section 52 calculates the voltage V to obtain a transfer voltage A. The transfer voltage A when the sheet 21 does not exist is determined.

When a print process occurs, the photoconductive drum 55 starts to rotate by the instruction from the control section 52.

The exposure unit 57 uses a modulated laser light to generate an electrostatic latent image on the photoconductive drum 55.

The developing unit 58 develops the electrostatic latent image with toner. A black development image is formed on the surface of the photoconductive drum 55.

In the image forming section 53, after the toner image is transferred, the toner remaining on the photoconductive drum 55 is removed by the blade 59.

Besides, the control section 52 starts to operate a mechanism to convey the sheet 21. The mechanism extracts the sheet 21 from the sheet feed cassette 14, and starts the conveyance operation of the sheet 21. Register rollers 23a and 23b correct a skew of the sheet 21.

The control section 52 continues to monitor the signal from the switch 24. The control section 52 detects, based on the signal from the switch 24 and the timer value, whether or not the sheet 21 passes through.

After detecting the existence of the sheet 21, the control section 52 starts to operate the Vpp measurement section 25.

As shown in FIG. 6A, the sheet 21 is nipped between the detection rollers 40 and 39. The control section 52 causes a bias to be applied to the Vpp measurement section 25.

A sheet impedance measurement section 26 measures the impedance of the sheet 21 and notifies the measurement value to the control section 52.

The control section 52 causes a signal source 37 to apply an AC bias signal to the detection roller 40.

The control section 52 causes a voltage detection circuit 41 to detect a peak-to-peak voltage at point A′ of FIG. 9.

The control section 52 measures the peak-to-peak voltage when the sheet 21 is being nipped between the detection rollers 40 and 39. The control section 52 detects the impedance of the sheet 21.

The control section 52 refers to the voltage compensation table 52a based on the detected peak-to-peak voltage. The control section 52 determines a compensation voltage B in substantially the same way as that of the example in which the relation of FIG. 8 is used.

The control section 52 reads plural records having values close to the detected Vpp value from the voltage compensation table 52a. The control section 52 obtains the compensation voltage B(V) by linear interpolation algorithm.

The control section 52 adds the transfer voltage A obtained by flowing the constant current to the transfer nip 73 when the sheet 21 does not exist to the compensation voltage B obtained using the detection rollers 40 and 39. The control section 52 determines the voltage obtained by the addition as the final transfer bias.

The control section 52 notifies the value of the determined transfer bias to the power source circuit 60.

The control section 52 causes the transfer roller 54 to contact with the photoconductive drum 55. The transfer nip 73 is formed between the transfer roller 54 and the photoconductive drum 55.

Before the sheet 21 reaches the transfer nip 73 or when it reaches the nip, the power source circuit 60 applies the determined transfer bias to the sheet 21.

The transfer roller 54 nips the sheet 21 between the outer peripheral surface of the transfer roller 54 and the outer peripheral surface of the photoconductive drum 55.

The transfer roller 54 is brought into press contact with the photoconductive drum 55. The toner image is transferred to the surface of the sheet 21. The sheet 21 on which the toner image is transferred is peeled off from the transfer roller 54.

The sheet 21 is conveyed to the fixing unit 16. The fixing unit 16 fixes the toner image to the sheet 21. The sheet 21 is conveyed to the storage tray 17 and is discharged to the outside of the machine.

By doing so, the transfer bias having the optimum value corresponding to the electric characteristic of the sheet 21 can be applied.

Also in the second embodiment, the transfer bias is compensated by the voltage Vpp measured immediately before the transfer.

In the image forming apparatus of the second embodiment, even if the resistance value of the transfer roller 54 is changed, the control in view of the change of the resistance value of the transfer roller 54 becomes possible by the transfer voltage A measured before the transfer. The transfer device resistant to the environmental change can be realized.

### Modified Example of the Second Embodiment

The above operation is the example of the case where the image forming apparatus of the second embodiment is the monochrome copier. The operation in the case where an image forming apparatus of a modified example of the second embodiment is a color copier is also the same as that of the above example.

FIG. 10 is a view showing a main part of the color copier including the image forming apparatus of the modified example of the second embodiment. In the drawing, the same reference numeral as the previously-mentioned reference numeral denotes the same component.

A color image forming apparatus 61 includes a photoconductive drum 62, and image forming sections 63, 64, 65 and 66 for a first color to a fourth color. Each of the image forming sections 63, 64, 65 and 66 includes a charging device, an exposure device and a developing device.

The charging devices, the exposure devices and the developing devices for the four colors are provided in the circumferential direction of the outer peripheral surface of the photoconductive drum 62 at 12 places in total. The charging devices, the exposure devices and the developing devices are provided with a gap from the outer peripheral surface of the photoconductive drum 62.

In the color image forming apparatus 61 having the structure as stated above, a control section 67 causes the transfer roller 54 to contact with the photoconductive drum 62 to form a transfer nip 68, and causes the power source circuit 60 to apply a constant current to the transfer nip 68.

The control section 67 causes a power source circuit 60 to detect a voltage V at point B′ in FIG. 10 and obtains a transfer voltage A when a sheet 21 does not exist.

When a print process occurs, the drum starts to rotate in the counterclockwise direction.

The image forming section 63 performs first color charging, exposure and development to the photoconductive drum 62.

The drum further rotates. The image forming section 64 performs second color charging, exposure and development to the photoconductive drum 62 on which the first color toner image exists.

Subsequently, the drum rotates. The image forming section 65 and the image forming section 66 perform third color charging, exposure and development and fourth color charging, exposure and development to the photoconductive drum 62 in order.

The four color toner images are formed on the surface of the photoconductive drum 62.

The control section 67 detects the existence of the sheet 21 by a signal from the switch 24.

In a Vpp measurement section 25, the sheet 21 is nipped by using detection rollers 40 and 39. The Vpp measurement section 25 applies a bias. A sheet impedance measurement section 26 measures the impedance of the sheet 21.

A voltage detection circuit 41 detects a peak-to-peak voltage at point A′.

The control section 67 obtain a compensation voltage B (V) by using the peak-to-peak voltage and a voltage compensation table 52a. The control section 67 adds the transfer voltage A to the compensation voltage B. The control section 67 determines the voltage obtained by the addition as the final transfer bias.

The transfer roller 54 transfers the toner image on the photoconductive drum 62 to the sheet 21.

After transferring the toner image to the sheet 21, the photoconductive drum 62 further rotates. A blade 59 removes the remaining toner on the photoconductive drum 62.

According to the image forming apparatus of the modified example of the second embodiment, the transfer bias can be compensated also in the color copier of the direct transfer system.

Incidentally, in the embodiments, although the copier is used as the image forming apparatus, the image forming apparatus of the embodiment may be an MFP (Multi-Function Peripheral), a facsimile, a laser printer or the like.

In the embodiments, the surface material of the detection roller 40 is semiconductive polyimide. With respect to the detection roller 39, a rubber material having a volume resistivity within a range of 10⁸ Ωcm to 10⁹ Ωcm, which is equal to the volume resistance value of the transfer roller 54, is used.

Even when the resistance change of the rubber material is large as compared with semiconductive polyimide, the control section can distinguish between the resistance change of the roller electrode and the resistance change of the sheet 21 by the transfer voltage A. Accordingly, a structure may be adopted in which one of the roller electrodes is made of rubber having a volume resistance value comparable to the volume resistance value of the transfer roller, and the other is a semiconductive polyimide electrode.

The structures of the circuits and equivalent circuits described in the embodiments can be variously modified. Also for the signals, various waveforms can be selected.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
an image forming section configured to include an image carrier and forms a developer image on the image carrier;
a transfer section configured to transfer the developer image on the image carrier to a recording medium;
a transfer bias supply section configured to supply a transfer bias voltage to the transfer section;
an electrode pair provided upstream of the transfer section in a conveyance direction of the recording medium and configured to nip the recording medium and to apply an AC bias to the recording medium;
a characteristic detection section configured to detect an electric characteristic value of the recording medium when the electrode pair applies the AC bias;
a storage section configured to store a corresponding relation between the detected characteristic value and a transfer bias value; and
a control section configured to refer to the corresponding relation of the storage section based on the characteristic value detected by the characteristic detection section and to compensate the transfer bias value applied to the recording medium.

2. The apparatus of claim 1, further comprising a mechanism configured to detect an electric characteristic value of a transfer member constituting the transfer section, wherein
the control section uses the electric characteristic value to compensate the transfer bias value.

3. The apparatus of claim 2, wherein a surface of at least one electrode of the electrode pair is provided with an elastic body.

4. The apparatus of claim 2, wherein a material of a surface of at least one electrode of the electrode pair is semiconductive polyimide.

5. The apparatus of claim 2, wherein
the transfer section includes a primary transfer roller configured to transfer the developer image on the image carrier to an intermediate transfer body, and a secondary transfer roller configured to transfer the developer image transferred by the primary transfer roller to the recording medium,
a surface of one electrode of the electrode pair being covered with a material equal to a material of the intermediate transfer body, and a surface of the other electrode being covered with a material equal to a material of a roller surface of the secondary transfer roller.

6. The apparatus of claim 5, wherein
the material of the surface of the one electrode is semiconductive polyimide.

7. The apparatus of claim 2, wherein
the control section includes an execution propriety selection section configured to selectively switching between turning-on and turning-off of a process of detecting the characteristic value of the recording medium.

8. The apparatus of claim 7, wherein
the control section causes a process speed of the image forming section when the process is on to become lower than a process speed of the image forming section when the process is off.

9. The apparatus of claim 1, further comprising:
a register roller configured to convey the recording medium to the transfer section, and a switch provided downstream of the register roller in the conveyance direction and upstream of the electrode pair in the conveyance direction and configured to detect the recording medium, wherein
the electrode pair being operable to contact with and to separate from the recording medium,
after a specified time passes since a detection signal is received from the switch, the control section causes the electrode pair to contact with the recording medium, thereby causing the electrode pair to apply the AC bias to the recording medium, reads the transfer bias value corresponding to the characteristic value detected by the characteristic detection section from the storage section, and uses the transfer bias value to compensate the transfer bias voltage from the transfer bias supply section.

10. The apparatus of claim 9, wherein a surface of at least one electrode of the electrode pair is provided with an elastic body.

11. The apparatus of claim 9, wherein a material of a surface of at least one electrode of the electrode pair is semiconductive polyimide.

12. The apparatus of claim 9, wherein
the transfer section includes a primary transfer roller configured to transfer the developer image on the image carrier to an intermediate transfer body, and a secondary transfer roller configured to transfer the developer image transferred by the primary transfer roller to the recording medium,
a surface of one electrode of the electrode pair being covered with a material equal to a material of the intermediate transfer body, and a surface of the other electrode being covered with a material equal to a material of a roller surface of the secondary transfer roller.

13. The apparatus of claim 12, wherein
the material of the surface of the one electrode is semiconductive polyimide.

14. The apparatus of claim 9, wherein
the control section includes an execution propriety selection section configured to selectively switching between turning-on and turning-off of a process of detecting the characteristic value of the recording medium.

15. The apparatus of claim 14, wherein
the control section causes a process speed of the image forming section when the process is on to become lower than a process speed of the image forming section when the process is off.

16. A transfer bias compensation method of an image forming apparatus, the method comprising the steps of:
forming, by an image forming section configured to include an image carrier, a developer image on the image carrier;
nipping, by an electrode pair provided upstream of a transfer section configured to transfer the developer image on the image carrier to a recording medium in a conveyance direction of the recording medium, the recording medium and applying an AC bias to the recording medium;
detecting, by a characteristic detection section configured to detect an electric characteristic value of the recording medium, the characteristic value; and
referring to, by a control section, a corresponding relation of a storage section configured to store a corresponding relation between a characteristic value of the recording medium and a transfer bias value based on the characteristic value detected by the characteristic detection section, and compensating a transfer bias value applied to the recording medium.

17. The method of claim 16, wherein
the compensation by the control section is the compensation of the transfer bias value, using an electric characteristic value detected by a mechanism configured to detect the electric characteristic value of a transfer member constituting the transfer section.

18. The method of claim 16, wherein
before formation of the developer image by the image forming section, a switch provided downstream of a register roller and configured to convey the recording medium to the transfer section in the conveyance direction and upstream of the electrode pair in the conveyance direction detects the recording medium,
after a specified time passes since a detection signal is received from the switch, the control section causes the electrode pair operable to contact with and to separate from the recording medium, to contact with the recording medium, thereby causing the electrode pair to apply an AC bias to the recording medium,
the control section reads, from the storage section, a transfer bias value corresponding to the characteristic value from the characteristic detection section, and uses the transfer bias value to compensate a transfer bias voltage from a transfer bias supply section to supply the transfer bias voltage to the transfer section.

19. The method of claim 16, wherein when the control section turns on a process of detecting the characteristic value of the recording medium, a process speed of the image forming section when the process is on is made lower than a process speed of the image forming section when the process is off.

20. The method of claim 16, wherein
when the recording medium does not exist, the control section obtains a first bias value by using a result obtained when a current is applied to a transfer nip,
when the recording medium exists, the characteristic detection section obtains a second bias value by using a result obtained when the AC bias is applied to the transfer nip by using one electrode a surface of which is covered with a material equal to a material of an intermediate transfer body and the other electrode a surface of which is covered with a material equal to a material of a surface of the transfer section, and
the control section determines, based on a bias value obtained by adding the first bias value to the second bias value, a transfer bias voltage from a transfer bias supply section to supply the transfer bias voltage to the transfer section.
